(19) United States
(12) Patent Application Publication
(10) Pub. No.: US 2026/0022681 A1
(43) Pub. Date: Jan. 22, 2026

(54) FUEL INJECTOR

(71) Applicant: PHINIA DELPHI LUXEMBOURG SARL, Belvaux (LU)

(72) Inventor: Mark HARPER, Drybrook Gloucestershire (GB)

(21) Appl. No.: 18/994,964

(22) PCT Filed: Jul. 6, 2023
(86) PCT No.: PCT/EP2023/068736

§ 371 Date: Jan. 15, 2025

(30) Foreign Application Priority Data
Jul. 15, 2022 (GB) 2210466.5

(51) Int. Cl. F02M 21/02

(52) U.S. Cl. CPC F02M 21/0263; F02M 21/0206; F02M 21/0251

(57) ABSTRACT

A fuel injector of a fuel injection system for delivering gaseous fuel to an internal combustion engine comprises: an injector nozzle having a valve needle that is movable within a bore of the injector nozzle; a needle control valve; a first fluid supply network for conveying the control fluid from a first injector inlet to an inlet of the needle control valve; a second fluid supply network for conveying the gaseous fuel from a second injector inlet to a delivery chamber, defined around the valve needle in the bore of the injector nozzle, for injection into the engine; and one or more sealant chambers for sealing respective leakage paths of the second fluid supply network, each leakage path extending between respective adjacent bodies of the fuel injector and the respective sealant chamber being defined at interfacing surfaces of those bodies to enclose that leakage path.

### FIELD OF THE INVENTION

The invention relates to a fuel injector for use in a fuel injection system of an internal combustion engine. Aspects of the invention relate to a fuel injector and to a fuel injection system for an internal combustion engine.

### BACKGROUND TO THE INVENTION

Fuel injectors are provided in fuel injection systems to inject fuel at high pressure into the associated combustion cylinders. Each fuel injector includes an injector nozzle having a valve needle, which is typically operated by means of an actuator to move towards and away from a valve seat. In this manner, the valve needle may be moved to control the fuel delivery into the combustion cylinder through one or more spray holes, or nozzle outlets, at the tip of the injector nozzle.

However, when a gaseous fuel, such as hydrogen, is used, a high flow rate is required to deliver enough gas into the combustion cylinder in the time available. In part, this is because the available injection pressure may vary in dependence on the pressure remaining in the fuel tank, which reduces as more fuel is used. A large valve seat is therefore typically required to provide a sufficient flow rate into the combustion cylinder.

However, increasing the flow rate in this manner leads to increased reaction forces acting against the nozzle return spring, which must therefore be sized appropriately. Consequently, typical direct acting injectors do not have the magnetic force required to lift the valve needle and open the nozzle against the force of the return spring.

It is against this background that the invention has been devised.

### SUMMARY OF THE INVENTION

According to an aspect of the invention, there is provided a fuel injector of a fuel injection system for delivering gaseous fuel to an internal combustion engine. The fuel injector comprises: an injector nozzle having a valve needle that is movable within a bore of the injector nozzle for controlling delivery of the gaseous fuel to the internal combustion engine; a needle control valve for controlling the movement of the valve needle by controlling the pressure of a control fluid in a control chamber of the needle control valve; a first fluid supply network for conveying the control fluid from a first injector inlet to an inlet of the needle control valve; a second fluid supply network for conveying the gaseous fuel from a second injector inlet to a delivery chamber, defined around the valve needle in the bore of the injector nozzle, for injection into the engine; and one or more sealant chambers for sealing respective leakage paths of the second fluid supply network, each leakage path extending between respective adjacent bodies of the fuel injector and the respective sealant chamber being defined at interfacing surfaces of those bodies to enclose that leakage path, wherein each sealant chamber is connected to the first fluid supply network such that, in use, each sealant chamber is supplied with the control fluid from the first fluid supply network at a higher pressure than the supply of fuel in the second fluid supply network, thereby substantially inhibiting leakage from the second fluid supply network via the respective leakage path.

In use, the fuel injector is therefore configured to receive the control fluid for controlling the closing force on the valve needle and, separately, to receive the gaseous fuel for injection into the engine. The needle control valve is operable to control the control fluid pressure in the control chamber, and thereby to control the closing force on the valve needle, independently of the control fluid pressure in the rest of the first fluid supply network. Advantageously, as the control fluid and the fuel are separated in the fuel injector, and received in respective supply networks, a pressure difference can be maintained between the supply networks and the sealant chambers connected to the first fluid supply network can be used to substantially inhibit leakage of gaseous fuel from the second fluid supply network by virtue of the pressure difference. The invention therefore provides for ease of lifting the valve needle whilst the fuel injector is able to function across a broad range of gaseous fuel pressures without leakage of the gaseous fuel.

Optionally, at least one of the leakage paths of the second fluid supply network may be defined between interfacing surfaces of the valve needle and the bore of the injector nozzle. That is, the leakage path between the fuel delivery chamber and the control chamber that arises due to the clearance between the interfacing surfaces of the valve needle and the bore of the injector nozzle for allowing relative movement of the valve needle. Optionally, the respective sealant chamber may be defined, at least in part, by a recess in the bore of the injector nozzle at that interface. In this manner, the sealant chamber may substantially inhibit leakage of the gaseous fuel from the delivery chamber. Optionally, the sealant chamber may be configured such that a lubricating flow of control fluid leaks, in use, from the sealant chamber into the delivery chamber. In this manner, the control fluid may lubricate the surfaces and mitigate wear. In examples, the lubricating flow of control fluid leaks from the sealant chamber to the delivery chamber and thereby lubricates the downstream interfaces between the valve needle and the injector bore, including at the valve seat. In examples, the lubricating flow of control fluid may additionally lubricate any further guide formations provided for the valve needle in the injector bore. In this respect, the lubricating flow of control fluid advantageously lubricates the interface between a tip of the valve needle and the valve seat, where high contact pressures develop. This is important because, in some examples, the gaseous fuel in the delivery chamber may provide limited lubrication. Hence, the lubricating flow of control fluid significantly reduces wear and damage to the valve needle and/or injector nozzle.

In an example, the valve needle is matched to the bore of the injector nozzle, or vice versa, such that the clearance between the interfacing surfaces of the valve needle and the bore of the injector nozzle provides or controls the lubricating flow of control fluid from the sealant chamber to the delivery chamber. For example, the valve needle may be matched to the bore such that the clearance is less than or equal to 2 micrometres. The valve needle may be matched to the bore of the injector nozzle by finishing at least one of the valve needle and the bore with a match grinding process, for example.

Optionally, at least one of the leakage paths of the second fluid supply network is defined between interfacing surfaces of axially adjacent first and second bodies of the fuel injector, for example in an area of connection between respective conduits of the second fluid supply network in the first and second bodies. The respective sealant chamber may be defined, at least in part, by a recess in the interfacing surfaces of at least one of the first and second bodies, for example surrounding the area of connection, to seal the leakage path, in use.

In an example, the one or more sealant chambers includes a plurality of sealant chambers. For example, the plurality of sealant chambers may be configured to seal respective leakage paths of the second fluid supply network at each mating face or controlled clearance of the fuel injector.

Optionally, at least one of the sealant chambers includes an annular chamber enclosing the respective leakage path. In other examples, the sealant chambers may take any suitable form encircling the respective leakage path.

The gaseous fuel may, for example, be hydrogen gas. In this context, the invention is particularly advantageous, due to the need for a large valve seat for adequate flow rate of hydrogen.

Optionally, the control fluid is conveyed as a liquid fluid in the first fluid supply network, in use. Optionally, the control fluid is a hydraulic fluid or a diesel fuel.

In an example, the fuel injector further comprises a return spring urging the valve needle against a valve seat of the injector nozzle.

Optionally, the second fluid supply network includes a first high pressure line and a second high pressure line, each extending from the second injector inlet to the delivery chamber. Each of the first and second high pressure lines therefore extends through respective bodies of a fuel delivery portion, and the needle control valve, and into the nozzle body.

Optionally, the first fluid supply network includes: a first high pressure line extending from the first injector inlet to the inlet of the needle control valve, and respective branches extending from the first high pressure line to each sealant chamber. In this manner, each sealant chamber is supplied with control fluid at delivery pressure. The pressure of each sealant chamber is therefore independent of the operation of the needle control valve.

In an example, the needle control valve includes one or more electromagnetic valves operable to selectively connect the inlet of the needle control valve, and/or an outlet of the needle control valve, to the control chamber, and thereby to control, in use, a pressure of the control chamber.

Optionally, the one or more electromagnetic valves include a three-way valve selectively connecting the control chamber to the inlet in a closed state of the fuel injector or the outlet in an open state of the fuel injector.

The control chamber may, for example, be arranged such that the control fluid in the control chamber acts on a distal surface of the valve needle. The distal surface may have a diameter that is greater than a diameter of the valve seat of the injector nozzle.

According to another aspect of the invention there is provided a fuel injection system for delivering gaseous fuel to an internal combustion engine comprising a fuel injector as described in a previous aspect of the invention. The internal combustion engine may be a hydrogen engine, for example. The fuel injection system may include a first fluid delivery system for delivering the control fluid to the fuel injector and a second fluid delivery system for delivering the fuel to the fuel injector.

According to another aspect of the invention there is provided a method of controlling fuel injection from a fuel injection system comprising: a fuel injector as described in a previous aspect of the invention; a first fluid delivery system for delivering the control fluid to the fuel injector; and a second fluid delivery system for delivering the fuel to the fuel injector. The method comprises: supplying the first fluid supply network with control fluid from the first fluid delivery system; supplying the second fluid supply network with fuel from the second fluid delivery system; and controlling fuel injection from the fuel injector by: operating the needle control valve to reduce the pressure of the control fluid in the control chamber of the needle control valve and thereby initiate fuel injection; subsequently operating the needle control valve to increase the pressure of the control fluid in the control chamber and thereby cut-off fuel injection; and controlling at least one of the first and second fluid delivery systems to provide a pressure difference between the first and second fluid supply networks during the fuel injection, such that each sealant chamber is supplied with the control fluid from the first fluid supply network at a higher pressure than the supply of fuel in the second fluid supply network, thereby substantially inhibiting leakage from the second fluid supply network via the respective leakage path.

Optionally, at least one of the first and second fluid delivery systems is controlled to provide a pressure difference between the first and second fluid supply networks that generates a lubricating flow of control fluid from the sealant chamber, defined at least partly by the recess in the bore of the injector nozzle, to the delivery chamber.

It will be appreciated that the various features of each aspect of the invention are equally applicable to, alone or in appropriate combination with, other aspects of the invention.

### BRIEF DESCRIPTION OF THE DRAWINGS

In order that the invention may be more readily understood, preferred non-limiting embodiments thereof will now be described, by way of example only, with reference to the accompanying drawings, in which like features are assigned like reference numbers, and in which:

FIG. 1 is an isometric view of an example fuel injector in accordance with an embodiment of the present invention, shown with wire-frame bodies; and

FIG. 2 is an enlarged isometric view of a portion of the fuel injector, shown in FIG. 1;

FIG. 3 is a schematic illustration of an injection portion of the example fuel injector shown in FIG. 1; and

FIGS. 4 to 7 schematically illustrate the injection portion of the fuel injector, shown in FIG. 3, during various stages of an injection cycle.

In the following description, directional or relative references such as ‘upper’, ‘lower’, ‘above’ and ‘below’, relate to the orientation of the features as illustrated in the drawings, but such references are not to be considered limiting. The skilled reader will appreciate that fuel injectors in accordance with embodiments of the invention may be oriented differently to the manner depicted in the drawings in practice.

### DETAILED DESCRIPTION OF EMBODIMENTS OF THE INVENTION

Embodiments of the present invention relate to a gaseous fuel injector for an internal combustion engine. As is conventional, the fuel injector includes an injector nozzle having a bore and a valve needle that is movable within the bore for controlling delivery of a gaseous fuel to the internal combustion engine. The fuel injector also includes a needle control valve for controlling the movement of the valve needle by controlling the pressure of a control fluid in a control chamber of the needle control valve. The fuel injector therefore includes separate fluid supply networks for conveying respective supplies of the control fluid and the fuel. A first fluid supply network extends through the fuel injector to convey the control fluid from a first injector inlet to an inlet of the needle control valve and a second fluid supply network extends through the fuel injector to convey the fuel from a second injector inlet to a delivery chamber, defined around the valve needle in the bore of the injector nozzle.

The needle control valve is operated to control the pressure of the control fluid in the control chamber and thereby to allow the valve needle to lift away from a valve seat of the injector nozzle, such that fuel is injected from the delivery chamber to the combustion chamber of the engine.

Advantageously, embodiments of the invention further include one or more sealant chambers for sealing respective leakage paths of the second fluid supply network. In particular, leakage paths of the second fluid supply network that exist at the interfaces of adjacent bodies of the fuel injector, for example where axially adjacent bodies connect together and/or where respective bodies of the fuel injector are designed to move relative to one another, e.g. at an interface between the valve needle and the bore of the injector nozzle. Each sealant chamber is defined at the interfacing surfaces of such bodies to enclose the leakage path and each sealant chamber connects to the first fluid supply network such that, in use, each sealant chamber is filled with the control fluid at a higher pressure than the fuel in the second fluid supply network. In this manner, the sealant chambers substantially inhibit leakage from the second fluid supply network via the respective leakage path. To give an example, such a sealant chamber may be defined at the interfacing surfaces of the valve needle and the bore of the injector nozzle. The gaseous fuel is therefore substantially inhibited from passing the sealant chamber due to a pressure difference that exists between the control fluid and the gaseous fuel. However, a small amount of control fluid may be allowed to leak from the sealant chamber into the fuel delivery chamber, which serves to lubricate the interface and mitigate wear.

It is envisaged that the fuel injector will therefore substantially inhibit leakage of the gaseous fuel, while the needle control valve provides for increased needle response, and accurate control of injections, particularly close to peak cylinder pressure.

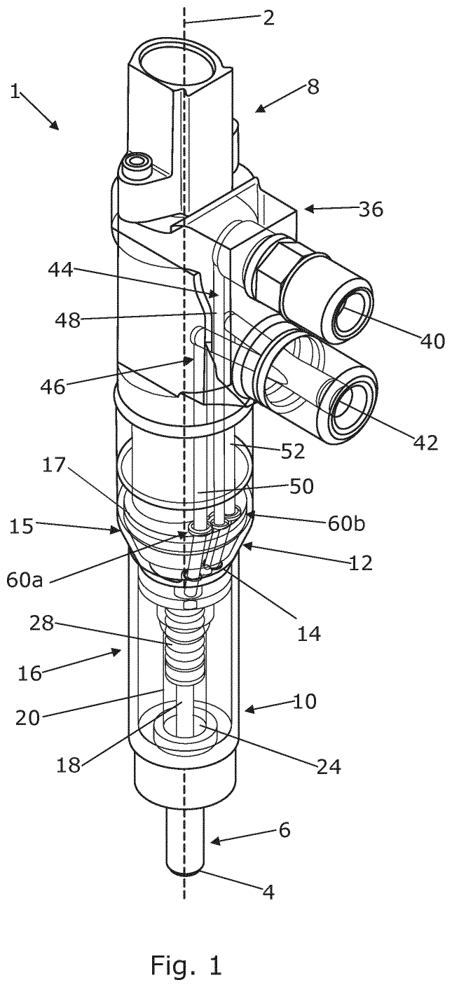

The fuel injector shall now be discussed in more detail with reference to the example embodiment shown in FIGS. 1 to 3.

FIG. 1 shows an exemplary fuel injector 1 in accordance with an embodiment of the present invention extending along a longitudinal axis 2 from a tip 4, at a proximal end 6, to an opposing distal end 8 that connects to various fluid delivery systems (not shown).

The fuel injector 1 is composed of a series of sub-assemblies, including an injector nozzle 10 and a needle control valve 12 for controlling the supply of a gaseous fuel, such as hydrogen, to an internal combustion engine (not shown).

The injector nozzle 10 includes a nozzle body 16 and a generally cylindrical valve needle 18. The nozzle body 16 extends along the longitudinal axis 2 from the tip 4, at the proximal end 6, to an opposing distal end 14 that connects to a body 15 of the needle control valve 12. The valve needle 18 is slidable within a cylindrically-shaped blind bore 20 provided in the nozzle body 16. The bore 20 extends along the longitudinal axis 2 from the distal end 14 of the nozzle body 16 to the tip 4 at the proximal end 6. The bore 20 is shaped to define a delivery chamber 24, between the valve needle 18 and the bore 20, to which fuel is delivered, in use, from a fuel supply line (not shown in FIG. 1). The valve needle 18 is movable axially to engage with, and disengage from, a valve seat (not shown in FIG. 1) defined by the blind end of the bore 20. In this manner, the valve needle 18 is moved towards and away from the valve seat to control the fuel delivery into a combustion chamber (not shown in FIG. 1) into which the fuel injector 1 protrudes, in use.

The movement of the valve needle 18, toward and away from the valve seat, is controlled by the needle control valve 12 and a return spring 28 acts to urge the valve needle 18 against the valve seat to close-off injection.

In this example, the needle control valve 12 is a hydraulically controlled electromagnetic control valve actuator, which is provided with a supply of control fluid from a supply network arranged in the fuel injector 1.

The fuel injector 1 therefore includes separate fluid supply networks for conveying the control fluid to the needle control valve 12 and for conveying the gaseous fuel, such as hydrogen, to the delivery chamber 24.

For this purpose, the fuel injector 1 further includes a fluid delivery body 36 connected to a distal end 17 of the needle control valve body 15. The fluid delivery body 36 includes a first injector inlet 40 for connection to a first fluid delivery system (not shown), providing a supply of control fluid, and a second injector inlet 42 for connection to a second fluid delivery system (not shown), providing a supply of fuel, which may be a gaseous fuel. For example, the second injector inlet 42 may connect to a high-pressure common rail or a hydrogen gas tank, providing a supply of pressurised gaseous fuel.

Importantly, the first injector inlet 40 is provided with the control fluid at a higher delivery pressure than the fuel supply to the second injector inlet 42, for example with a pressure difference of at least 10 bar, preferably at least 15 bar, relative to the gaseous fuel supply. In examples, the first fluid delivery system may therefore be controlled to maintain the pressure difference as the amount of gaseous fuel in a supply tank decreases, reducing the pressure of the gaseous fuel supply. In other words, the delivery pressure of the control fluid provided by the first fluid delivery system may vary in dependence on the delivery pressure of the gaseous fuel, maintaining a pressure difference of 10 to 15 bar for example.

The fuel injector 1 also includes a first fluid supply network 44 for conveying the control fluid from the first injector inlet 40 to the needle control valve 12 and a second fluid supply network 46 for conveying the gaseous fuel from the second injector inlet 42 to the delivery chamber 24.

As shown in FIG. 1, the first fluid supply network 44 includes a high-pressure line 48 that extends from the first injector inlet 40, through the fluid delivery body 36, to the inlet 29 of the needle control valve 12, which is defined in the needle control valve body 15.

The second fluid supply network 46 includes a first high-pressure line 50 and a second high-pressure line 52, each extending from the second injector inlet 42, through the fluid delivery body 36 and the needle control valve body 15, to the delivery chamber 24 defined in the bore 20 of the nozzle body 16.

The second fluid supply network 46 therefore extends through a series of bodies of the fuel injector 1 and conveys a gaseous fuel, such as hydrogen, in use. Successive conduits of each of the first and second high-pressure lines 50, 52 therefore meet and connect at the interfaces of the axially adjacent bodies 15, 16, 36 of the fuel injector 1. Ordinarily, there is therefore a risk of leakage of the gaseous fuel from the second fluid supply network 46 along respective leakage paths defined between the adjacent bodies 15, 16, 36. For example, leakage paths may extend between the interfacing surfaces of the adjacent bodies 15, 16, 36 around the connections of the successive conduits. It shall be appreciated that the term ‘leakage path’ is used in this context to refer to an unintended leakage from the first and second high-pressure lines 50, 52.

Advantageously, fuel injectors 1 according to the present invention include respective sealant chambers 60a-d arranged between such interfaces to enclose, and seal-off, such leakage paths. In particular, each sealant chamber 60a-d is connected to the first fluid supply network 44 by a respective branch 62a-d such that, in use, the sealant chamber 60a-d is filled with the control fluid at a higher pressure than the gaseous fuel in the second fluid supply network 46. In this manner, the pressure difference ensures that, in the event of separation or other causes of leakage at the interface, the gaseous fuel will not escape the second fluid supply network 46. Instead, the pressure difference ensures that any leakage occurs in the direction of the control fluid entering the second fluid supply network 46. Accordingly, as the control fluid may enter the second fluid supply network 46 in the event of leakage, it is preferable for the control fluid to be a combustible fuel, such as a diesel fuel, since the leaked control fluid may be injected into the internal combustion engine.

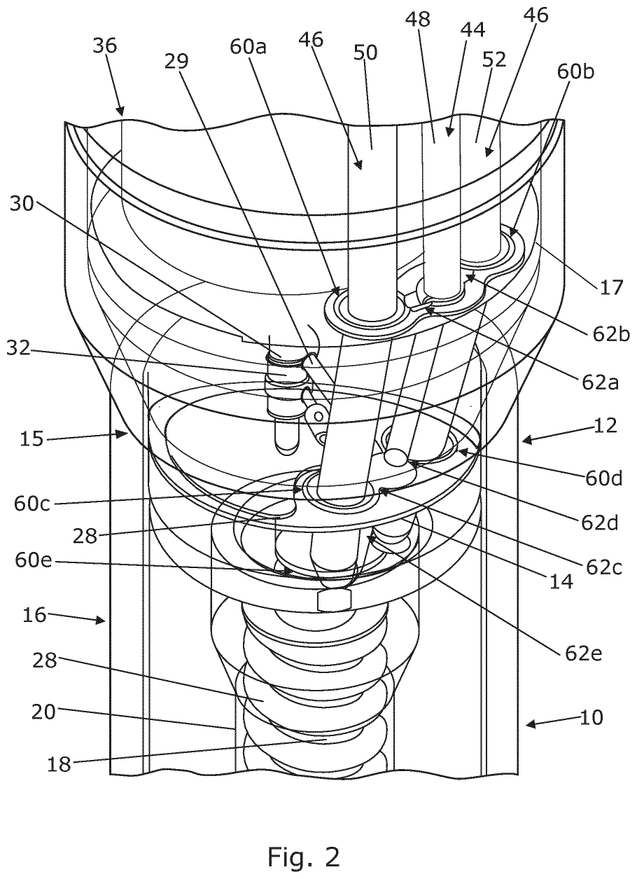

The example sealant chambers 60a-d are illustrated in more detail in FIG. 2, as shall now be described in more detail. In this example, the fuel injector 1 is shown to include first, second, third, and fourth sealant chambers 60a-d for sealing respective leakage paths of the second fluid supply network 46 at mating interfaces of the fuel injector 1. The first sealant chamber 60a is defined at the interface of the fluid delivery body 36 and the needle control valve body 15. In particular, the first sealant chamber 60a is defined by complementary recessed formations in the interfacing surfaces of the fluid delivery body 36 and the needle control valve body 15, which meet in assembly to define the first sealant chamber 60a at the interface. The first sealant chamber 60a is shown to take the form of an annular chamber, in this example. The annular chamber surrounds the respective openings of the connected conduits of the first high pressure line 50 at the interface. In this manner, to the extent that the gaseous fuel could leak from the conduits along a leakage path between the interfacing surfaces, the first sealant chamber 60a completely encloses such a leakage path.

In a corresponding manner, the second sealant chamber 60b is also provided in the form of an annular chamber that encloses the connection of the second high pressure line 52 at the interface between the fluid delivery body 36 and the needle control valve body 15. As shown in FIG. 2, each of the first and second sealant chambers 60a,b is connected to the first fluid supply network 44 by respective branches 62a,b extending from the from the high-pressure line 48 such that, in use, the first and second sealant chambers 60a,b are filled with the control fluid and the pressure of such sealant chambers 60a,b is therefore controlled by the first fluid delivery system attached to the first injector inlet 40. In other examples, it shall be appreciated that each of the first and second sealant chambers 60a, 60b may be provided in other forms that encircle the connections of the first and second high pressure lines 50, 52 at the interface.

The third and fourth sealant chambers 60c, 60d operate in a corresponding manner at the interface between the needle control valve body 15 and the nozzle body 16. Specifically, the third and fourth sealant chambers 60c, 60d form respective annular chambers that surround the connections of the first and second high-pressure lines 50, 52 of the second fluid supply network 46 at the interface between the needle control valve body 15 and the nozzle body 16. The third and fourth sealant chambers 60c, 60d are similarly supplied with control fluid by respective branches 62c, d from the high-pressure line 48 of the first fluid supply network 44 such that each of the third and fourth sealant chambers 60c, 60d is filled with the control fluid and maintained at the pressure of the high-pressure line 48.

In this manner, leakage of gaseous fuel into the first fluid supply network 44 at each mating interface is substantially eliminated.

In embodiments, the fuel injector 1 may also include a sealant chamber 60e arranged at the interface between the valve needle 18 and the bore 20, as shown in FIG. 2, where a clearance fit exists to allow the valve needle 18 to move along the bore 20. In particular, the clearance fit presents a potential leakage path of the second fluid supply network 46 extending from the delivery chamber 24, between the interfacing surfaces of the valve needle 18 and the bore 20. To inhibit such leakage, the additional sealant chamber 60e may be defined by a recessed formation in a wall of the bore 20, forming an annular chamber defined around the valve needle 18. The annular sealant chamber may similarly be provided with a supply of control fluid from the first fluid supply network 44 via a further branch 62e from the high-pressure line 48 such that the annular sealant chamber 60e is maintained at a higher pressure, in use, than the gaseous fuel in the delivery chamber 24. In this manner, the pressure differential substantially inhibits the leakage of gaseous fuel from the delivery chamber 24 to the needle control valve 12. However, in examples, a small amount of control fluid may be allowed to leak from the sealant chamber 60e into the fuel delivery chamber 24, which serves to lubricate the interface and mitigate wear. In order to control such leakage, the clearance between the valve needle 18 and the bore 20 may be tightly controlled during manufacture. In particular, the valve needle 18 may be matched to the bore 20 of the injector nozzle 10, or vice versa, such that the clearance between the interfacing surfaces of the valve needle 18 and the bore 20 of the injector nozzle 10 controls the lubricating flow of control fluid from the sealant chamber 60e to the delivery chamber 24. For example, the valve needle 18 may be matched to the bore 20 such that the clearance is less than or equal to 2 micrometres, or even less than or equal to 1.5 micrometres.

For this purpose, one of the valve needle 18 and the bore 20 may be finished by a match grinding process to match the other of the valve needle 18 and the bore 20. For example, the match griding process may involve measuring, grinding, and calibrating the two parts to match each other with a clearance of less than or equal to 2 micrometres, preferably less than or equal to 1.5 micrometres. In this manner, a controlled leakage of control fluid is generated from the sealant chamber 60e to the delivery chamber 24 when the first and/or second fluid delivery systems are operated to provide or maintain a pressure difference between the first and second fluid supply networks 44, 46, in use. The control fluid therefore travels towards the tip 4 of the fuel injector 1 and lubricates the interfacing surfaces arranged proximally of the sealant chamber 60e. This may include any further guiding formations (not shown) arranged around the valve needle 18 for guiding the valve needle 18 in the bore 20 of the injector nozzle 10. Importantly, the controlled leakage further lubricates the valve seat of the injector nozzle 10, which the valve needle 18 repeatedly engages and disengages. This is important because, in some examples, the gaseous fuel in the delivery chamber 24 may provide insufficient lubrication at the valve seat. Hence, the lubricating flow of control fluid significantly reduces wear and damage to the valve needle 18 and/or injector nozzle 10.

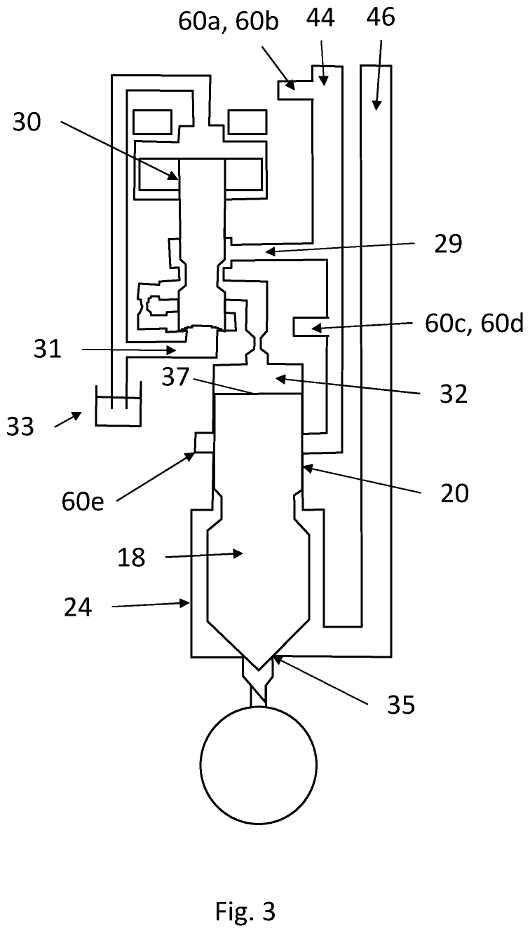

FIG. 3 provides a schematic illustration of the first and second fluid supply networks 44, 46 and the respective connections to the needle control valve 12, the sealant chambers 60a-e and the delivery chamber 24.

As shown in FIG. 3, the first fluid supply network 44 connects to an inlet 29 of the needle control valve 12, such that the inlet 29 is supplied with control fluid at the delivery pressure, i.e. at the pressure of the high-pressure supply line 48. The needle control valve 12 further includes a control chamber 32 arranged at a distal end of the valve needle 18 and control fluid is supplied from the inlet 29 to the control chamber 32 to exert pressure on the valve needle 18, urging the valve needle 18 towards the valve seat 35. The needle control valve 12 also includes an outlet 31 connected to a low pressure return line 33 and an electromagnetic control valve 30 for selectively connecting the inlet 29 and/or the outlet 31 to the control chamber 32. In this manner, the electromagnetic control valve 30 controls the pressure of the control fluid in the control chamber 32. For example, the electromagnetic control valve 30 may take the form of a three-way valve, as shown in FIG. 3, for selectively connecting: (i) the inlet 29 to the control chamber 32 to provide a supply of high-pressure control fluid to the control chamber 32; and/or (ii) the control chamber 32 to the outlet 31 to reduce the pressure of the control fluid in the control chamber 32, as shall be described in more detail. The control fluid in the control chamber 32 acts on a distal surface 37 of the valve needle 18 and generates a force acting to urge the valve needle 18 against the valve seat 35 and thereby to close nozzle outlets at the end of the bore 20, cutting-off injection. In examples, such a distal surface 37 may, for example, be provided by a distal end of the valve needle 18 or a distal end of a command piston (not shown) that acts, in turn, to displace the valve needle 18 within the bore 20. Notably, in examples, the distal surface 37 has a greater diameter than the valve seat 35 such that the valve needle 18 engages the valve seat 35, and the nozzle remains closed, when the electromagnetic valve 30 connects the control chamber 32 to the first fluid supply network 44 (as shown in FIG. 3).

FIG. 3 also schematically shows the connections between the first fluid supply network 44 and each of the sealant chambers 60a-e, such that each of the sealant chambers 60a-e is provided with the control fluid at the delivery pressure from the high-pressure line 48. In this manner, the sealant chambers 60a-e are provided with high-pressure control fluid from the supply line 48, and the pressure of the sealant chambers 60a-e is substantially independent of the operation of the needle control valve 12.

The second fluid supply network 46 is also schematically shown in FIG. 3 and connects to the fuel delivery chamber 24, such that the fuel delivery chamber 24 is supplied with pressurised gaseous fuel. In this manner, the gaseous fuel in the delivery chamber 24 acts on proximal surfaces of the valve needle 18 to generate a lifting force that acts against the closing forces of the return spring 28 and the pressurised control chamber 32. Hence, when the needle control valve 12 reduces the pressure in the control chamber 32, the gaseous fuel can lift the valve needle 18 and open the nozzle outlets for injecting the fuel into the combustion chamber.

It shall be appreciated that the needle control valve 12 is therefore operated to adjust the pressure in the control chamber 32, and thereby controls the closing force exerted on the valve needle 18 to allow opening and closing of the fuel injector 1. The needle control valve 12 may therefore include a control system for adjusting the position of the electromagnetic control valve 30 and thereby controlling the pressure of the control fluid in the control chamber 32. Alternatively or additionally, the needle control valve 12 may receive commands signals from an external control system, such as an engine control unit. Various methods are known in the art for controlling an electromagnetic needle control valve in this manner, which will not be described in detail here to avoid obscuring the invention. By way of example only, the control system may be configured to control the position of the electromagnetic valve 30 in dependence on one or more inputs including, but not limited to, an injection cycle programmed for the fuel injector 1, a fuel pressure in the delivery chamber 24 and/or an amount of fuel in a storage tank of the fuel delivery system.

A manner of operating the fuel injector 1 shall now be described with reference to FIGS. 3 to 7, which schematically illustrate the fuel injector 1 during various stages of an injection cycle.

As shown in FIG. 3, initially the needle control valve 12 is operated to connect the inlet 29 to the control chamber 32, and to close-off the pathway to the outlet 31. The control chamber 32 is therefore provided with control fluid at the delivery pressure, which generates a closing force on the valve needle 18 and urges the valve needle 18 against the valve seat 35, preventing injection.

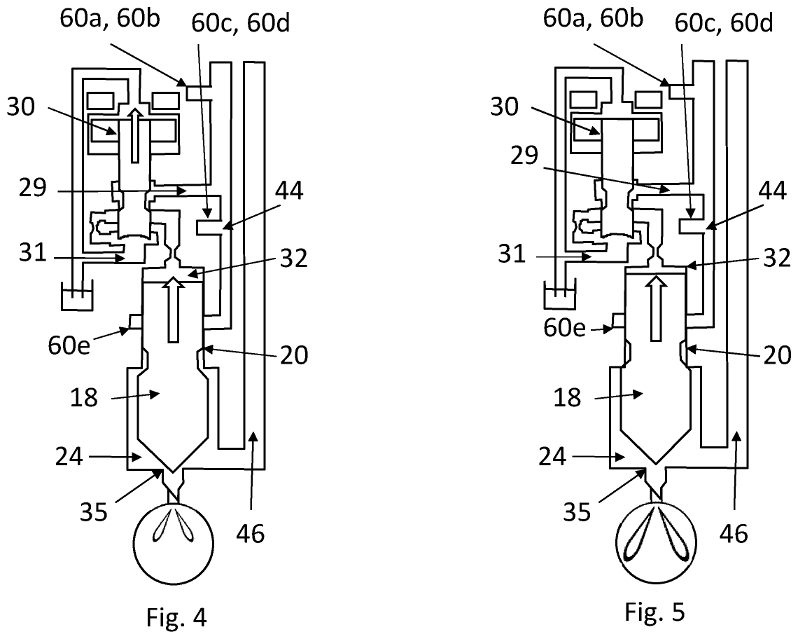

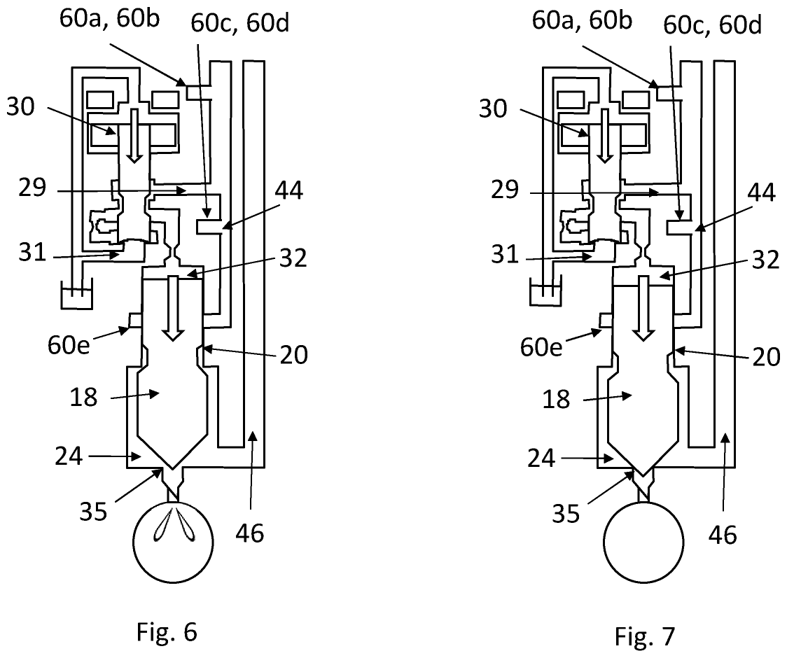

Subsequently, when fuel injection is required, the electromagnetic needle control valve 30 is operated to connect the control chamber 32 to the outlet 31 and to cut-off the supply from the inlet 29, thereby reducing the pressure in the control chamber 32. As shown in FIG. 4, the pressure in the control chamber 32 therefore reduces below the pressure of the gaseous fuel, allowing the valve needle 18 to lift away from the valve seat 35 (against the spring return force) for fuel injection to being. As the needle control valve 12 remains in such an open state, the valve needle 18 moves further away from the valve seat 35 to a fully open position, as shown in FIG. 5, allowing a maximum rate of fuel injection. Subsequently, to cut-off fuel injection, the electromagnetic valve 30 is actuated to a closed position to connect the inlet 29 to the control chamber 32 once more and to seal off the outlet 31. Consequently, the pressure in the control chamber 32 rapidly returns to the delivery pressure and the valve needle 18 is urged back towards the valve seat 35, as shown in FIG. 6, until the fuel injector 1 is closed once again, as shown in FIG. 7, with the valve needle 18 engaging the valve seat 35.

The invention therefore provides for ease of lifting the valve needle 18 whilst providing a large valve seat for a high flow rate of gaseous fuel. Additionally, since the sealant chambers 60a-e can be maintained at the delivery pressure, independent of the operation of the needle control valve 12, a pressure difference is maintained between the sealant chambers 60a-e and the enclosed leakage paths, substantially inhibiting leakage of gaseous fuel from the second fluid supply network 46.

It shall be appreciated that, as the supply of gaseous fuel reduces, the pressure in the delivery chamber 24 shall also reduce. Hence, the first fluid delivery system (not shown) may be controlled accordingly to reduce the pressure of the control fluid in the first fluid supply network 44, and to maintain a pressure difference of approximately 10 to 15 bar between the sealant chambers 60a-e and the gaseous fuel in the second fluid supply network 46.

In this manner, the fuel injector 1 is able to function across a broad range of gaseous fuel pressures, allowing injection pressures between 50 bar and 300 bar, for example. It is also envisaged that the fuel injector 1 of the present invention will therefore provide increased needle response, and accurate control of injections, without harmful risk of gaseous fuel leaking into the needle control valve 12.

It will be appreciated by a person skilled in the art that the invention could be modified to take many alternative forms to that described herein, without departing from the scope of the appended claims.

### REFERENCES USED

1—Fuel injector
2—Longitudinal axis (of fuel injector)
4—Tip (of fuel injector)
6—Proximal end (of fuel injector)
8—Distal end (of fuel injector)
10—Injector nozzle
12—Needle control valve
14—Distal end (of nozzle body)
15—Needle control valve body
16—Nozzle body
17—Distal end (of the needle control valve body)
18—Valve needle
20—Bore
24—Delivery chamber
28—Return spring
29—Inlet (of needle control valve)
30—Electromagnetic control valve
31—Outlet (of needle control valve)
32—Control chamber
33—Return line
34—Piston
35—Valve seat
36—Fluid delivery body
37—Distal Surface
40—First inlet
42—Second inlet
44—First fluid supply network
46—Second fluid supply network
48—High-pressure line (of first fluid supply network)
50—First high-pressure line (of second fluid supply network)
52—Second high-pressure line (of second fluid supply network)
60a-e—Sealant chambers
62a-e—Branches to first fluid supply network

1. A fuel injector of a fuel injection system for delivering gaseous fuel to an internal combustion engine, the fuel injector comprising:
an injector nozzle having a valve needle that is movable within a bore of the injector nozzle for controlling delivery of the gaseous fuel to the internal combustion engine;
a needle control valve for controlling the movement of the valve needle by controlling the pressure of a control fluid in a control chamber of the needle control valve;
a first fluid supply network for conveying the control fluid from a first injector inlet to an inlet of the needle control valve;
a second fluid supply network for conveying the gaseous fuel from a second injector inlet o a delivery chamber, defined around the valve needle in the bore of the injector nozzle, for injection into the engine; and
one or more sealant chambers for sealing respective leakage paths of the second fluid supply network, each leakage path extending between respective adjacent bodies of the fuel injector and the respective sealant chamber being defined at interfacing surfaces of those bodies to enclose that leakage path, wherein each sealant chamber is connected to the first fluid supply network such that, in use, each sealant chamber is supplied with the control fluid from the first fluid supply network at a higher pressure than the supply of fuel in the second fluid supply network, thereby substantially inhibiting leakage from the second fluid supply network via the respective leakage path.

2. A fuel injector according to claim 1, wherein at least one of the leakage paths of the second fluid supply network is defined between interfacing surfaces of the valve needle and the bore of the injector nozzle, and the respective sealant chamber is defined, at least in part, by a recess in the bore of the injector nozzle at that interface.

3. A fuel injector according to claim 2, wherein the valve needle is matched to the bore of the injector nozzle such that a clearance between the interfacing surfaces of the valve needle and the bore of the injector nozzle provides a lubricating flow of control fluid from the sealant chamber, defined at least partly by the recess in the bore of the injector nozzle, to the delivery chamber, optionally, wherein the clearance between the interfacing surfaces of the valve needle and the bore of the injector nozzle is less than or equal to 2 micrometres, and/or the valve needle is matched to the bore of the injector nozzle by finishing at least one of the valve needle and the bore with a match grinding process.

4. A fuel injector according to claim 1, wherein at least one of the leakage paths of the second fluid supply network is defined between interfacing surfaces of axially adjacent first and second bodies of the fuel injector, in an area of connection between respective conduits of the second fluid supply network in the first and second bodies, and wherein the respective sealant chamber is defined, at least in part, by a recess in the interfacing surfaces of at least one of the first and second bodies, surrounding the area of connection, to seal the leakage path, in use.

5. A fuel injector according to claim 1, wherein the one or more sealant chambers includes a plurality of sealant chambers, optionally, wherein one or more of the plurality of sealant chambers are configured to seal respective leakage paths of the second fluid supply network at each mating face or controlled clearance of the fuel injector.

6. A fuel injector according to claim 1, wherein at least one of the sealant chambers includes an annular chamber enclosing the respective leakage path.

7. A fuel injector according to claim 1, wherein the gaseous fuel is hydrogen gas.

8. A fuel injector according to claim 1, wherein the control fluid is conveyed as a liquid fluid in the first fluid supply network, in use, optionally, wherein the control fluid is a hydraulic fluid or a diesel fuel.

9. A fuel injector according to claim 1, further comprising a return spring urging the valve needle against a valve seat of the injector nozzle.

10. A fuel injector according to claim 1, wherein the second fluid supply network includes a first high pressure line and a second high pressure line, each extending from the second injector inlet to the delivery chamber.

11. A fuel injector according to claim 1, wherein the first fluid supply network includes: a first high pressure line extending from the first injector inlet to the inlet of the needle control valve, and respective branches extending from the first high pressure line to each sealant chamber.

12. A fuel injector according to claim 1, wherein the needle control valve includes one or more electromagnetic valves operable to selectively connect the inlet of the needle control valve, and/or an outlet of the needle control valve, to the control chamber, and thereby to control, in use, a pressure of the control chamber, optionally, wherein the one or more electromagnetic valves include a three-way valve selectively connecting the control chamber to the inlet in a closed state of the fuel injector or the outlet in an open state of the fuel injector.

13. A fuel injector according to claim 1, wherein control fluid in the control chamber acts on a distal surface of the valve needle, and wherein the distal surface has a diameter that is greater than a diameter of the valve seat of the injector nozzle.

14. A fuel injection system for delivering gaseous fuel to an internal combustion engine comprising a fuel injector according to claim 1, optionally, wherein the internal combustion engine is a hydrogen engine.

15. A method of controlling fuel injection from a fuel injection system comprising: a fuel injector according to claim 1; a first fluid delivery system for delivering the control fluid to the fuel injector; and a second fluid delivery system for delivering the fuel to the fuel injector; the method comprising:
supplying the first fluid supply network with control fluid from the first fluid delivery system;
supplying the second fluid supply network with fuel from the second fluid delivery system; and
controlling fuel injection from the fuel injector by:
operating the needle control valve to:
reduce the pressure of the control fluid in the control chamber of the needle control valve and thereby initiate fuel injection; and
subsequently increase the pressure of the control fluid in the control chamber to thereby cut-off fuel injection; and
controlling at least one of the first and second fluid delivery systems to provide a pressure difference between the first and second fluid supply networks during the fuel injection, such that each sealant chamber is supplied with the control fluid from the first fluid supply network at a higher pressure than the supply of fuel in the second fluid supply network, thereby substantially inhibiting leakage from the second fluid supply network via the respective leakage path.

16. A method according to claim 15, wherein at least one of the first and second fluid delivery systems is controlled to provide a pressure difference between the first and second fluid supply networks that generates a lubricating flow of control fluid from the sealant chamber, defined at least partly by the recess in the bore of the injector nozzle, to the delivery chamber.
